(19) United States
(12) Patent Application Publication
(10) Pub. No.: US 2011/0171342 A1
(43) Pub. Date: Jul. 14, 2011

(54) CONFECTIONERY PRODUCTS PROVIDING AN INCREASED HYDRATION SENSATION

(76) Inventors: David R. Phillips, III, Chicago, IL (US); Sheau Meng Chin, Chicago, IL (US); April J. Aackett, Chicago, IL (US); Marcia Petit, Chicago, IL (US); Chia-Hua Hsu, Glenview, IL (US); Thomas Richard Koziel, Lemont, IL (US); Ann Weìford Allanson, Chicago, IL (US); David G. Barkalow, Deerfield, IL (US)

(21) Appl. No.: 13/058,699

(22) PCT Filed: Aug. 12, 2009
(86) PCT No.: PCT/US09/53581

§ 371 Date: Apr. 1, 2011

Related U.S. Application Data
(60) Provisional application No. 61/088,943, filed on Aug. 14, 2008.
(60) Provisional application No. 61/141,447, filed on Dec. 30, 2008.

(51) Int. Cl. A23G 4/18; A23L 1/236; A23G 4/00; A23G 3/20

(52) U.S. Cl. 426/2; 426/548; 426/3; 426/103; 426/5

(57) ABSTRACT

A confectionary product (such as a chewing gum or candy) contains an effective mouthwatering amount of erythritol in a form of granules including coarse granules or a combination of fine and coarse granules. Further a confectionary product incorporates an effective mouthwatering amount of erythritol contained in a filled bead or in combination with a food-grade acid.

### BACKGROUND

The present invention relates to confectionery products. More particularly, the present invention relates to confectionery products such as chewing gum products and candy, which provide a hydration or mouthwatering sensation to a consumer.

Consumers have expressed a desire for a confectionary product such as a chewing gum or candy, which produces a mouthwatering or hydration sensation during consumption of such confectionary product. Confectionary products have been described as increasing salivation or treating xerostomia (a medical term describing dry mouth due to lack of salivation) which include ingredients such as acids or xylitol. However, consumers seek more satisfying confectionary product than are provided by products containing such ingredients.

Confectionery products such as chewing gum are popular among consumers. Typically, a chewing gum contains a water-insoluble elastomeric chewing gum base and a water-soluble bulking agent such as a sugar or sugar alcohol, combined with various flavoring agents. Typically, a sweetener component is incorporated into a chewing gum as a sugar (such as sucrose) or a high intensity sweetener. Some of these sweeteners and flavoring agents may cause some consumers to experience a mouth drying sensation and may cause the consumer to feel a need to drink water or a water-containing liquid. In addition, many individuals suffer from a dry mouth from time to time due to a variety of physiological and environmental factors such as when exercising or when in a dry climate. Therefore, there is a need for confectionery products that provide an increased hydration sensation to a consumer upon consumption to alleviate sensations of dry mouth experienced by the consumer.

Chewing gum confectionary products have been described which contain sugar alcohols such as sorbitol, mannitol, xylitol, maltitol, and erythritol. However, as described in this invention, incorporation of granular erythritol alone or in combination with other components provides a confectionary product, which produces a superior hydration or mouthwatering effect to a consumer upon consumption.

In aspects of this invention, an effective mouthwatering perception is produced using coarse erythritol granules and in other aspects an enhanced mouthwatering perception is produced by combining erythritol granules with components such as filled beads or food-grade acids.

### SUMMARY OF INVENTION

A confectionary product (such as a chewing gum or candy) contains an effective mouthwatering amount of erythritol in a form of granules including coarse granules or a combination of fine and coarse granules. Further, a confectionary product incorporates an effective mouthwatering amount of erythritol in combination with a food-grade acid. Further, a confectionary product incorporates an effective mouthwatering amount of erythritol in combination with filled beads.

### DESCRIPTION OF EMBODIMENTS

Consumers of confectionary products such as chewing gum have expressed a desire in consumer tests for a product which produces a fresh clean mouth feeling which is connected to a perceived sense of hydration. Such a hydration sensation refers to a mouthwatering or mouth moistening effect from a sense of increased salvation or moisture content in a consumer's mouth. This hydration or mouthwatering sensation is distinct and distinguishable from a “cooling” sensation caused by known cooling agents such as menthol. Such a mouthwatering sensation is not designed as a treatment for a medical condition known as xerostemia.

Although confectionery products of this invention do not supply significant quantities of water or liquid to a consumer, consumers have reported through sensory tests that confectionery products including granular erythritol, alone or in combination with other components, produce a pleasing sensation of mouth hydration. Particularly, consumer tests have determined that inclusion of larger erythritol granules in a confectionary product containing acid, such as a chewing gum, produces a hydration or mouthwatering effect greater than that with erythritol in smaller granules. Further, a mouthwatering sensation may be produced using a portion of smaller erythritol granules without an undue sense of crunchiness caused by large erythritol granules in the confectionery product.

Further, coarse erythritol granules, fine erythritol granules, or blends of coarse and fine erythritol granules having specific particle sizes and/or in combination with filled beads provide a sensation of hydration that consumers like over confectionery products lacking such blends of erythritol granules. A mouthwatering effect of the erythritol granules also can be created using smaller erythritol granules without an undue sense of crunchiness in the confectionery product.

An improved hydration sensation may arise from a fresh clean mouth feeling while chewing and after having completed chewing such a confectionery product. After chewing or consumption of a product of this invention, many consumers do not feel a need to rinse their mouth or take a drink of water. In contrast, too much flavor or too intense flavor may make a consumer want to rinse their mouth or take a drink. Thus, there is a detriment to having too much flavor component in a confectionery product such as chewing gum.

Confectionery products useful in this invention preferably are chewing gums but may be other food products in the form of jelly candies, pressed tablets, mints, chewy candies, hard boiled candies, chocolates, nougats, licorice, taffy, gels, solid foam, crystallized pastes, or combinations thereof. Such confectionery products also may include non-traditional confectionery products including food products such as granola bars, energy/sports bars, fruit leathers, and the like.

In an aspect of this invention, a confectionery product is a chewing gum in a form of pellets, sticks, tabs, dragees, chicklets, batons, molded shapes or combinations thereof.

In further aspects of this invention, a confectionery product may include one or more additional ingredients such as malted products, sweeteners, flavors, colors, medicaments, actives, or combinations thereof.

In an aspect of this invention, a confectionery product delivers a sensation of hydration containing coarse erythritol. In another aspect, the confectionery product comprises a blend of coarse erythritol granules and fine erythritol granules. In another aspect, a confectionery product of this invention contains either coarse erythritol granules or fine erythritol granules in sufficient amounts to provide a sensation of hydration to a consumer. In a preferred embodiment, a confectionery product is a chewing gum having such sufficient amounts of erythritol granules. In another preferred embodiment, a confectionery product is a chewing gum having such sufficient amounts of erythritol granules and filled beads. In addition to the sensation of hydration or mouthwatering, an erythritol blend may also provide crunchiness to the confectionery product depending on the distribution of the coarse erythritol and fine erythritol in the blend.

In accordance with this invention, erythritol granules are incorporated into confectionary products (as used and defined herein) alone or in combination with other components to produce a hydration sensation. Such erythritol granules are present in confectionary products of this invention in sufficient quantity to produce a hydration or mouthwatering effect as determined by consumer tests. A “mouthwatering effective amount” of erythritol is an amount of erythritol required to produce a mouthwatering or mouth moistening sensation to a consumer and preferably to a majority of consumers.

In a preferred aspect of this invention, coarse erythritol granules are incorporated into confectionary products to produce a mouthwatering effect to consumers. In such aspect, a large granule size (or “coarse”) erythritol may be included in combination with less expensive bulking agents such as sorbitol, mannitol, xylitol, maltitol, and the like to produce an effective mouthwatering perception to a consumer.

As with many powdered materials, “coarseness” or “fineness” is described by the percentage of materials within a specific granular or particle size. The amount of a sample which is a particular particle size is identified by passing the powder sample through a series of screens. The smaller particles pass through the screen and the large particles are retained by or trapped on the screen.

As used here, the term “coarse erythritol granules” means erythritol crystalline granules are those that will not pass through a #60 ASTM E11 Series Sieve (i.e., a particle size not less than 250 μm). For example, a coarse erythritol has a particle size greater than about 250 μm including for example greater than 275 μm, 300 μm, 325 μm, 350 μm, 375 μm, 400 μm, 425 μm, 450 μm, 475 μm, 500 μm, 525 μm, 550 μm, 575 μm, 600 μm, 625 μm, 650 μm, 675 μm, 700 μm, 725 μm, 750 μm, 775 μm, 800 μm, 825 μm, 850 μm and the like. In another embodiment, the coarse erythritol also can have a maximum particle size such as, for example, 900 μm, 1000 μm, 1100 μm, 1200 μm, 1300 μm, 1400 μm, 1500 μm and the like. In practice erythritol granules sold as “coarse” may contain some small crystals, although typically at least 80% of such coarse erythritol particles are at least 250 μm. Preferably, at least 40% of such coarse erythritol granules are at least 354 μm. Table 1 illustrates a typical particle size distribution for sorbitol granules sold as “coarse.”

TABLE 1
Coarse Erythritol- Particle Size Distribution

| Particle size | Requirement | | | |
|---|---|---|---|---|
| ASTM E11 Sieves | Min. | Target | Max. | Units |
| Retained on #20 (>841 μm) | 0 | 15 | 30 | % |
| Retained on #45 (354 μm-841 μm) | 50 | 75 | 100 | % |
| Retained on #60 (250 μm-354 μm) | 80 | 90 | 100 | % |

As used here, the term “fine erythritol granules” means erythritol crystalline granules that pass through a #80 ASTM E11 Series Sieve (i.e., a particle size not more than 177 μm). In practice, erythritol granules sold as “fine” may include up 15% larger particles. Preferably, at least 75% of fine erythritol particles are no more than 53 μm. Table 2 illustrates a typical particle size distribution for sorbitol granules sold as “fine.”

TABLE 2
Fine Erythritol - Particle Size Distribution

| Particle size | Requirement | | | |
|---|---|---|---|---|
| ASTM E11 Sieves | Min. | Target | Max. | Units |
| Retained on #80 (>177 μm) | 0 | — | 10 | % |
| Retained on #270 (53 μm-177 μm) | 0 | — | 20 | % |
| Retained on #450 (25 μm-53 μm) | 10 | — | 45 | % |

In an embodiment, the coarse erythritol, fine erythritol or erythritol blend is in an amount ranging from about 5% to about 80% by weight the confectionery product. For example, the confectionery product may contain an amount of the coarse erythritol, fine erythritol or erythritol blend ranging from about 5% to about 80%, including 10%, 15%, 20%, 25%, 30%, 35%, 40%, 45%, 50%, 55%, 60%, 65%, 70%, 75%, and the like, by weight of the confectionery product.

In an embodiment, the erythritol blend comprises about 50% coarse erythritol and about 50% fine erythritol. In an embodiment, the coarse erythritol ranges from about 50% to about 99% by weight of the erythritol blend. For example, the erythritol blend can comprise an amount of coarse erythritol ranging from about 50% to about 99%, such as 55%, 60%, 65%, 70%, 75%, 80%, 85%, 90%, 95% and the like, by weight of the erythritol blend. A typical 50:50 blend of coarse and fine erythritol granules as sold contains at least about 40% and more typically at least about 45% coarse erythritol granules.

In an embodiment, the confectionery product comprises a food grade acid (i.e. an acidic compound acceptable as a food component) typically ranging from about 0.1% to about 5% by weight (preferably 1 to 4 wt. %) of the confectionery product. In this embodiment, the acid can add to or enhance the hydration sensation of the erythritol. Suitable food grade acids include, but are not limited to: citric, malic, lactic, ascorbic, tartaric, adipic, acetic, and fumaric acids.

In another embodiment, a confectionery product does not include an acid. As a result, the sensation of hydration comes from a combination of erythritol and filled beads or specific erythritol granules in suitable amounts.

In an aspect of this invention, a confectionary product (such as a chewing gum) contains an amount of coarse erythritol granules to produce a mouthwatering perception to many consumers (a “mouthwatering effective amount”). Typically, such a mouthwatering effective amount of coarse erythritol granules is at least 5 wt. %, more typically at least 10 wt. %, preferably at least 15 wt. %, and more preferably at least 20 wt. %, of a confectionary product. The amount of such coarse erythritol granules typically may range up to 80 wt. %, more typically up to 70 wt. %, and preferably up to 60 wt. % of a confectionary product. Typical ranges are 5 to 60 wt. % and 10 to 40 wt. % of a confectionary product.

The amount of coarse erythritol granules in a confectionary product (such as chewing gum) of this invention typically is at least 80 wt. % (preferably at least 90%) of the total erythritol granules contained in the confectionary product. In other aspects of this invention, the amount of coarse erythritol granules in a confectionary product (such as chewing gum) of this invention typically is at least 25 wt. % (preferably at least 40 wt. %) of the total erythritol granules contained in the confectionary product.

In an aspect of this invention in which coarse erythritol granules are combined with other bulking agents (such as other sugar alcohols), a typical amount of such coarse erythritol granules is at least 5 wt. %, more typically at least 10 wt. %, preferably at least 15 wt. %, of the confectionary product such other bulking agents or sugar alcohols are present in typical amounts of up to 25 wt. %, more typically up to 50 wt. %, and may range up to 70 wt. % of the confectionary product. Typical combinations of coarse erythritol granules and other bulking agent or sugar alcohols is 5 to 25 wt % coarse erythritol granules and 15 to 60 wt. % of other bulking agents such as other sugar alcohols.

In another aspect of this invention, a confectionary product such as a chewing gum contains an effective mouthwatering amount of erythritol granules (such as fine, coarse, or a combination of fine and coarse erythritol granules) of at least 40 wt. % and preferably at least 50 wt. % of the confectionary product.

In an alternative embodiment, the present disclosure provides a method of making a confectionery product that delivers a sensation of hydration. The method comprises combining the confectionery product with erythritol ranging from about 5% to about 80 wt. % and an amount of filled beads ranging from about 0.1% to about 5.0 wt. % of the confectionery product. The erythritol and the filled beads can be combined with the confectionery product using any suitable process.

In another embodiment, the present invention provides a method of making a confectionery product which delivers a sensation of hydration. In such method a confectionery product is combined with an erythritol blend of coarse erythritol and fine erythritol. The erythritol blend can be combined with the confectionery product using any suitable process and at any suitable stage of the confectionery manufacturing process.

An additional aspect of this invention is a confectionery product which incorporates filled beads in an amount sufficient to provide a hydration or mouthwatering sensation in a consumer's mouth. A preferred confectionery product of this invention is a chewing gum having a combination of erythritol granules and filled beads. Such a confectionery product contains erythritol ranging from about 5% to about 80 wt. % and an amount of filled beads ranging from about 0.1% to about 5.0 wt. % of the confectionery product. Such erythritol granules may be coarse, fine, or combinations thereof.

A confectionery product of this invention may contain at least one sensate. In an another aspect of this invention, a filled beads range from about 0.1% to about to about 5.0 wt. % of the confectionery product and the sensate ranges from about 0.01% to about 5 wt. % of the confectionery product.

A confectionery product of this invention containing flavor beads may contain an amount of coarse erythritol, fine erythritol or an erythritol blend (e.g. of the coarse erythritol and fine erythritol) from about 5% to about 80%, including 10%, 15%, 20%, 25%, 30%, 35%, 40%, 45%, 50%, 55%, 60%, 65%, 70%, 75% and the like, by weight of the confectionery product. In a preferred embodiment, the erythritol granules range from about 10% to about 60 wt. % of the confectionery product. In another preferred embodiment, the erythritol ranges from about 15% to about 30 wt. % of the confectionery product. In another preferred embodiment, the erythritol is about 20 wt. % of the confectionery product. In another preferred aspect, erythritol granules are used with other sugar alcohol bulking agents in weight ratios of 1:10 to 10:1, preferably 1:5 to 1:1.

Filled beads (sometimes called “flavor beads”) contain a liquid center, or core, which could include one or more flavors, and a polymer-containing shell encapsulating the liquid core. The core and/or shell of the bead may or may not contain a flavor or sensient component. Specific features of suitable beads, such as bead size and shell composition or thickness, typically depend on the intended application. For example, a bead may be designed to provide a relatively quick burst of flavor or may be designed to provide a more sustained flavor release, by controlling such features as shell thickness or composition.

Hydrophilic polymers suitable for use as a shell material for the flavor beads includes, for example, gelatin, agar, alginate, carrageenan, pectin, gellan gum, and combinations thereof.

The preferred beads in this invention contain a liquid core and a water soluble protein or hydrocolloid shell. Most preferred, is a bead with a gelatin shell. The shell dissolves in the mouth during mastication, producing a potentially slippery and moist mouthfeel. The preferred shell thickness is such that the beads are easily broken during mastication, releasing their liquid contents. If the beads contain a sensate or a flavor, the content level will not be so high as to create a lingering intense flavor. Consumer studies have shown that intensely flavored products cause a consumer to want to rinse their mouth.

A suitable core material typically is in a form of a water or oil based liquid mixture which may or may not contain a flavor or senseint. Irrespective of the precise method used to prepare a filled bead, liquid flavors suitable for use in accordance with the present disclosure include, for example, fruit flavors, mint flavors, spice flavors, and combinations of such flavors. These flavors may be natural or artificial (synthetic) in origin and often natural and artificial flavors are combined. Also a blend of different flavors together in consumer-pleasing combinations may be used. Although the range of flavors is nearly limitless, flavors commonly fall into several broad categories. Fruit flavors include lemon, orange, lime, grapefruit, tangerine, strawberry, apple, cherry, raspberry, blackberry, blueberry, banana, pineapple, cantaloupe, muskmelon, watermelon, grape, currant, mango, kiwi and many others as well as combinations. Mint flavors include spearmint, peppermint, wintergreen, basil, corn mint, menthol and others and mixtures thereof. Spice flavors include cinnamon, vanilla, clove, chocolate, nutmeg, coffee, licorice, eucalyptus, ginger, cardamom, anise, and many others. Flavor beads useful in this invention also may include sensates to enhance the flavor or perceived breath freshening of the product or to provide additional consumer perceptions.

A mixture of core material useful in filled beads suitable in this invention also may include additional components such as a colorant, a solvent or diluent such as an edible oil (e.g., a medium chain triglyceride, soybean oil, olive oil, canola oil, or sunflower seed oil), and/or combinations thereof.

Diameters of suitable flavor beads useful in this invention also may vary depending on the intended application. Generally, an average bead diameter (for a population of beads) is less than 4000 μm (e.g., less than about 3500 μm, 3000 μm, 2500 μm, 2000 μm, 1500 μm, or even 1000 μm), as determined using sampling and measuring techniques known in the art. Also generally, a flavor bead useful in this invention has an average bead diameter greater than 1 μm, more typically greater than 10 μm, and usually greater than 100 μm. Typically, the average diameter of the beads may in some embodiments range from about 1 μm to about 5000 μm, from about 250 μm to about 3500 μm, or from about 300 μm to about 3000 μm. In embodiments in which the flavor beads are incorporated into a chewing gum or other confectionary product, the average diameter of the beads may be at or near the lower end of these ranges (e.g., about 200 μm to about 2000 μm, from about 500 μm to about 1500 μm, from about 800 μm to about 1200 μm, or about 1000 μm).

Confectionery products of this invention typically contain one or more additional ingredients such, for example, malted products, flavors, sensates, colors (e.g. azo free colors), sweetener, actives and medicaments (e.g. listed below). Such ingredients can be added in a free form or may be part of an encapsulation, compaction, granulation and agglomeration to provide, for example, protected and longer-lasting ingredient components such as flavors and sensates.

Sugar sweeteners may be added to the confection. Sugar sweeteners generally include saccharide-containing components commonly known in the confectionery art, including, but not limited to, sucrose, dextrose, maltose, dried invert sugar, fructose, levulose, tagatose, galactose, corn syrup solids, and the like, alone or in combination. Alternatively, sweeteners may include glycerin, fruit concentrates and fruit pastes.

Besides erythritol, various polyols may be used as a sugarless sweetener. These polyols can include, but are not limited to, other sugar alcohols such as xylitol, sorbitol, mannitol, isomalt, lactitol, hydrogenated starch hydrolysates, and the like, alone or in combination.

High intensity artificial or natural sweeteners also may be used alone or in combination with other sweeteners. Preferred high intensity sweeteners include, but are not limited to, sucralose, neotame, aspartame, salts of acesulfame, alitame, saccharin and its salts, cyclamic acid and its salts, stevioside, glycyrrhizin, dihydrochalcones, thaumatin, monellin, and the like, and combinations thereof. In order to provide a longer lasting sweetness and flavor sensation, such artificial sweetener may be encapsulated or otherwise in a form to provide a controlled release of at least a portion of the artificial sweetener. Such techniques as wet granulation, wax granulation, spray drying, spray chilling, fluid bed coating, coacervation, and fiber extension may be used to achieve desired release characteristics. Usage level of artificial sweetener can vary greatly and will depend on such factors as potency of the sweetener, rate of release, desired sweetness of the product, level and type of flavor used, and cost considerations.

If a low calorie confectionery is desired, a low caloric bulking agent can be used. Examples of low caloric bulking agents include: Raftilose; Raftilin; Palatinose oligosaccharide; and Guar Gum Hydrolysate (SUN FIBER®). However, other low calorie bulking agents may be used.

The flavorant or flavor used in the confectionery products may include any natural or synthetic oil and/or flavor as is commonly known in the art. Natural and artificial flavoring agents may be combined in any sensorially acceptable fashion. Flavor agents can be used in any suitable amount in the confectionery products. In an embodiment, the flavor ingredients comprise from about 0.1% to about 5 wt. % of the confectionery product.

Nonlimiting examples of suitable flavorants include natural and synthetic flavoring agents chosen from synthetic flavor oils and flavoring aromatics, and/or oils, oleo resins and extracts derived from plants, leaves, flowers, fruits, vegetables and so forth, and combinations thereof. Nonlimiting examples of flavor oils include spearmint oil, cinnamon oil, oil of wintergreen (methyl salicylate), peppermint oils, clove oil, bay oil, anise oil, eucalyptus oil, thyme oil, cedar leaf oil, oil of nutmeg, oil of sage, oil of bitter almonds, and cassia oil. Also nonlimiting examples of artificial, natural or synthetic fruit flavors include vanilla, cream, caramel, banana, cocoa, and citrus oil, including lemon, orange, grape, lime and grapefruit and fruit essences including apple, pear, peach, strawberry, raspberry, cherry, plum, pineapple, apricot and so forth. Flavors also may include any suitable pastes, powders and extracts of fruits and/or vegetables. Alternatively, flavors types may be salty, meaty, potato chip or crisp, and the like.

These flavorants may be used alone or in combination with or without a sensate such as, for example, a cooling or heating agent commonly known in the art. As used herein, the sensate/cooling excludes erythritol even though erythritol may provide a cooling effect. The flavorant or flavor may be encapsulated or non-encapsulated. Encapsulated flavorant may be used to increase or decrease the flavor release rate as is commonly known in the art.

Generally, sensates are compounds which cause a non-flavor sensory effect such as a cooling, heating, warming, tingling or numbing sensation to a consumer. Non-limiting examples of coolants include menthol, substituted p-menthane carboxamides, acyclic carboxamides, menthone glycerol ketals, menthyl lactate, menthyl succinate, 3-1-menthoxypropane-1,2 diol, and spearmint. Non-limiting examples of heating agents may include vanillyl alcohol n-butyl ether, vanillyl alcohol n-propyl ether, vanillyl alcohol isopropyl ether, vanillyl alcohol isobutyl ether, vanillyl alcohol n-amino ether, vanillyl alcohol isoamyl ether, vanillyl alcohol n-hexyl ether, vanillyl alcohol methyl ether, vanillyl alcohol ethyl ether, gingerol, shogaol, paradol, zingerone, capsaicin, dihydrocapsaicin, nordihydrocapsaicin, homocapsaicin, homodihydrocapsaicin, ethanol, iso-propyl alcohol, iso-amylalcohol, benzyl alcohol, chloroform, eugenol, cinnamon oil, cinnamic aldehyde and phosphate derivatives of same. Non-limiting examples of tingling agents may include Jambu Oleoresin or para cress (Spilanthes sp.) (the active ingredient being spiranthol), Japanese pepper extract (Zanthoxylum peperitum) having the active ingredient(s) known as Saanshool-I, Saanshool-II and Sanshoamide, black pepper extract (Piper nigrum) (having the active ingredients chavicine and piperine), echinacea extract, northern prickly ash extract, red pepper oleoresin, and effervescing agents, such as edible acids and bases.

Generally, ingredients known as “actives” include, but are not limited to, anti-oxidants, vitamins, minerals, stimulants, prebiotics, probiotics, enzymes, genetically modified organisms, nutritional supplements, yoghurt ingredients and whitening ingredients. Generally, medicaments include, but are not limited to, analgesics, antibiotics, antivirals, antihistamines, anti-inflammatories, decongestants, antacids, muscle relaxants, psychotherapeutic agents, insulin, diuretics, anesthetics, antitussives, anti-diabetic agents, bioengineered pharmaceuticals, nutraceuticals, traditional medicines and cardiovascular agents. A medicament may be used to treat conditions such as coughs, colds, motion sickness, allergies, fevers, pain, inflammation, sore throats, cold sores, sinus problems, diarrhea, diabetics, gastritis, depression, anxiety, hypertension, angina, and other maladies and symptoms.

Specific actives may include, by way of example and not limitation: b-glucan, isoflavones, omega-3 fatty acid, lignans, lycopene, allicin, glucosinolates, limonoids, fructose and a nondialyzable polymeric compound, polyphenols, catechins (e.g. epigallocatechin-3-gallate, epigallocatechin, epicatechin-3-gallate, epicatechin), phenolics, polyunsaturated fatty acids (PUFAs such as omega-3 (ω-3) fatty acids), soy protein, soy isolates, conjugated linoleic acid (CLA), caffeine, aspirin, nicotine, echinacea purpurea, ginseng, kola nut, capsicum, nettle, passion flower, St. Johns Wort, valerian, Ma Huang/guarana, kava kava and chamomile.

Vitamins include Vitamins A, B-complex (such as B-1, B-2, B-6 and B-12), C, D, E and K, niacin and acid vitamins such as pantothenic acid and folic acid and biotin. Minerals include compounds of calcium, iron, zinc, magnesium, iodine, copper, phosphorus, manganese, potassium, chromium, molybdenum, selenium, nickel, tin, silicon, vanadium and boron.

Specific medicaments include, by way of example and not limitation: aspirin, acetaminophen, ibuprofen, ketoprofen, cimetodine, ranitidine, famotidine, dramamine, omeprazole, dyclonine, chlorpheniramine maleate, pseudoephedrine, hydrochloride, dextromethorphan hydrobromide, benzocanine, sodium naproxen, hydroxycitric acid, chromium picolinate, phosphatidylserine, and insulin.

A preferred confectionary product of this invention is a chewing gum. As used herein, the term “chewing gum” includes bubble gum and confectionery products containing chewing gum. Unless otherwise specified, all percentages used herein are weight percents. A chewing gum generally contains a water-insoluble gum base portion, a water-soluble bulking agent portion, and flavors. Usually a water-insoluble gum base portion is retained in the mouth throughout a chew by a consumer, while the water-soluble portion dissipates with a portion of the flavoring agents over a period of time during chewing.

A suitable water-insoluble gum base typically contains elastomers, resins, fats and oils, softeners, and inorganic fillers and may or may not include wax. A water-insoluble gum base typically constitutes approximately 5 to about 95 wt. %, of a chewing gum, more commonly the gum base comprises 10 to about 50 wt. % of the gum, and in some preferred embodiments, 20 to about 35 wt. %, of the chewing gum.

In an embodiment, a suitable chewing gum of the present disclosure contains about 20 to about 60 weight percent synthetic elastomer, 0 to about 30 wt. % natural elastomer, about 5 to about 55 wt. % elastomer plasticizer, about 4 to about 35 wt. % filler, about 5 to about 35 wt. % softener, and optional minor amounts (about one percent or less) of miscellaneous ingredients such as colorants, antioxidants, and the like.

Synthetic elastomers may include, but are not limited to, polyisobutylene with a GPC (gel permeation chromatography) weight average molecular weight of about 10,000 to about 95,000, isobutylene-isoprene copolymer (butyl rubber) and styrene butadiene copolymers (SBR's) having styrene-butadiene ratios of about 1:3 to about 3:1, polyvinyl acetate having a GPC weight average molecular weight of about 2,000 to about 90,000, polyisoprene, polyethylene, vinyl acetate-vinyl laurate copolymer having vinyl laurate content of about 5 to about 50 wt. % of the copolymer, and combinations thereof.

Preferred average GPC molecular weight ranges for polyisobutylene is 50,000 to 80,000, and for polyvinyl acetate is 10,000 to 65,000 with the higher molecular weight polyvinyl acetates typically used in bubble gum base. For vinyl acetate-vinyl laurate copolymer, a preferable vinyl laurate content is 10-45 percent.

Natural elastomers include natural rubber such as smoked or liquid latex and guayule as well as natural gums such as jelutong, lechi caspi, perillo, sorva, massaranduba balata, massaranduba chocolate, nispero, rosindinha, chicle, gutta hang kang, and combinations thereof. Preferred synthetic elastomer and natural elastomer concentrations vary depending on whether the chewing gum in which the base is used is adhesive or conventional, bubble gum or regular gum, as discussed below. Preferred natural elastomers include jelutong, chicle, sorva and massaranduba balata.

Elastomer plasticizers include, but not limited to, natural rosin esters, often called ester gums, such as glycerol esters of partially hydrogenated rosin, glycerol esters polymerized rosin, glycerol esters of partially dimerized rosin, glycerol esters of rosin, pentaerythritol esters of partially hydrogenated rosin, methyl and partially hydrogenated methyl esters of rosin, pentaerythritol esters of rosin; synthetics such as terpene resins derived from alpha-pinene, beta-pinene, and/or d-limonene; and any suitable combinations of the foregoing the preferred elastomer plasticizers will also vary depending on the specific application, and on the type of elastomer which is used.

Fillers/texturizers include magnesium and calcium carbonate, ground limestone, silicate types such as magnesium and aluminum silicate, clay, alumina, talc, titanium oxide, mono-, di- and tri-calcium phosphate, cellulose polymers, such as wood, and combinations thereof.

Softeners/emulsifiers include tallow, hydrogenated tallow, hydrogenated and partially hydrogenated vegetable oils, cocoa butter, glycerol monostearate, glycerol triacetate, lecithin, mono-, di- and triglycerides, acetylated monoglycerides, fatty acids (e.g. stearic, palmitic, oleic and linoleic acids), and combinations thereof.

Colorants and whiteners include FD&C-type dyes and lakes, fruit and vegetable extracts, titanium dioxide, and combinations thereof.

A suitable gum base portion also may contain materials which allow it to be suitably combined with other confectioneries. For example, the chewing gum can be chocolate/fat tolerant, acid friendly, tack-free, and the like.

In addition to a water-insoluble gum base portion, a typical chewing gum composition includes a water-soluble bulking agent portion and one or more flavoring agents.

The water soluble portion typically includes bulk sweeteners, high intensity sweeteners, flavoring agents, softeners, emulsifiers, colors, sensates, acidulants, fillers, antioxidants, preservatives, actives, medicaments (as previously described) and other suitable components or processing aids or combinations thereof that provide desired attributes as known by the skilled artisan.

Softeners can be added to the chewing gum in order to optimize the chewability and mouth feel of the gum. The softeners, which are also known as plasticizers and plasticizing agents, generally constitute between approximately 0.5 to about 15 wt. % of the chewing gum.

The softeners may include caprenin, glycerin, lecithin and combinations thereof. Aqueous sweetener solutions such as those containing sorbitol, hydrogenated starch hydrolysates, corn syrup, other polyols or sugars, such as tagatose, and combinations thereof, may also be used as softeners and binding agents in chewing gum.

A variety of processes for manufacturing chewing gum center are possible as is known in the art. For example, chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, extruding into chunks, or casting into pellets.

Generally, the ingredients are mixed by first melting the gum base and adding it to the running mixer. The gum base may alternatively be melted in the mixer. Color and emulsifiers can be added at this time, along with liquids and a portion of the bulking agent. Further portions of the bulking agent may then be added to the mixer. A flavoring agent is typically added with the final portion of the bulking agent. The entire mixing procedure typically takes from five to fifteen minutes, but longer mixing times may sometimes be required. Those skilled in the art will recognize that many variations of the above described procedures may be followed. Preferably, the erythritol bulking agent is added in the second, or final, portion of the bulking agent addition. Preferably, the filled beads are added with the second portion, or after the second portion of bulking agent is added to the batch.

The invention described herein is illustrated but not limited by the following Examples and Comparative Runs.

### Example 1

Three chewing gums formulations containing varying combinations of erythritol granules and flavor beads were tested versus controls in a consumer sensory test. The three chewing gums are identified as Mint, Fruit #1, and Fruit #2.

The formulations of the Mint chewing gum are shown in Table 3. There was no acid component in any of the Mint samples. Acid was not part of the flavor profile of this product. Erythritol was present as coarse granules. The sorbitol and mannitol in sample #10 (control) was of standard grade (i.e. similar to “fine” erythritol granular size)

TABLE 3
Mint Formulation

| Ingredients | Samples | | | | | | | | | |
|---|---|---|---|---|---|---|---|---|---|---|
| (weight %) | #1 | #2 | #3 | #4 | #5 | #6 | #7 | #8 | #9 | #10 |
| Sorbitol | 59.7 | 38.7 | 43.7 | 58.9 | 42.9 | 37.9 | 58. | 37.1 | 42.1 | 46.3 |
| Mannitol | 0.15 | 0.15 | 0.15 | 0.15 | 0.15 | 0.15 | 0.15 | 0.15 | 0.15 | 4.0 |
| Erythritol | 0 | 21 | 16 | 0 | 16 | 21 | 0 | 21 | 16 | 0 |
| Hydrogenated | 0.5 | 0.5 | 0.5 | 0.5 | 0.5 | 0.5 | 0.5 | 0.5 | 0.5 | 0 |
| Starch | | | | | | | | | | |
| Hydrolysate | | | | | | | | | | |
| Gum Base | 30.0 | 30.0 | 30.0 | 30.0 | 30.0 | 30.0 | 30.0 | 30.0 | 30.0 | 32.0 |
| Filled Beads | 0.8 | 0.8 | 0.8 | 1.6 | 1.6 | 1.6 | 2.4 | 2.4 | 2.4 | 0 |
| Flavor, | 3.3 | 3.3 | 3.3 | 3.3 | 3.3 | 3.3 | 3.3 | 3.3 | 3.3 | 3.2 |
| Colors & | | | | | | | | | | |
| Sensates | | | | | | | | | | |
| High Intensity | 1.15 | 1.15 | 1.15 | 1.15 | 1.15 | 1.15 | 1.15 | 1.15 | 1.15 | 1.8 |
| Sweeteners | | | | | | | | | | |
| Acids | 0 | 0 | 0 | 0 | 0 | 0 | 0 | 0 | 0 | 0 |
| Oils/glycerin/ | 4.1 | 4.1 | 4.1 | 4.1 | 4.1 | 4.1 | 4.1 | 4.1 | 4.1 | 11.6 |
| lecithin | | | | | | | | | | |
| Water | 0.3 | 0.3 | 0.3 | 0.3 | 0.3 | 0.3 | 0.3 | 0.3 | 0.3 | 1.1 |
| Erthritol | Coarse | Coarse | Coarse | Coarse | Coarse | Coarse | Coarse | Coarse | Coarse | — |
| Granulation | | | | | | | | | | |

The formulations of Fruit #1 chewing gum samples are shown in Table 4. Erythritol was present as coarse granules. The sorbitol and mannitol in sample #10 (control) was of standard grade (i.e. similar to “fine” erythritol granular size).

TABLE 4
Fruit #1 Gum Formulations

| Ingredients | Samples | | | | | | | | | |
|---|---|---|---|---|---|---|---|---|---|---|
| (weight %) | #1 | #2 | #3 | #4 | #5 | #6 | #7 | #8 | #9 | #10 |
| Sorbitol | 50.2 | 37.9 | 33.6 | 49.4 | 37.1 | 32.8 | 48.6 | 36.3 | 32.0 | 51.5 |
| Mannitol | 0.29 | 0.17 | 0.15 | 0.29 | 0.17 | 0.15 | .29 | 0.17 | 0.15 | 0.29 |
| Erythritol | 0 | 16 | 21 | 0 | 16 | 21 | 0 | 16 | 21 | 0 |
| Hydrogenated | 1.04 | 0.63 | 0.55 | 1.04 | 0.63 | 0.55 | 1.04 | 0.63 | 0.55 | 1.04 |
| Starch | | | | | | | | | | |
| Hydrolysate | | | | | | | | | | |
| Gum Base | 32 | 32 | 32 | 32 | 32 | 32 | 32 | 32 | 32 | 31 |
| Filled Beads | 0.8 | 0.8 | 0.8 | 1.6 | 1.6 | 1.6 | 2.4 | 2.4 | 2.4 | 0 |
| Flavors, | 2.44 | 2.44 | 2.44 | 2.44 | 2.44 | 2.44 | 2.44 | 2.44 | 2.44 | 3.46 |
| Colors & | | | | | | | | | | |
| Sensates | | | | | | | | | | |
| Acid* | 3.00 | 3.00 | 3.00 | 3.00 | 3.00 | 3.00 | 3.00 | 3.00 | 3.00 | 1.00 |
| High Intensity | 1.91 | 1.91 | 1.91 | 1.91 | 1.91 | 1.91 | 1.91 | 1.91 | 1.91 | 1.78 |
| Sweeteners | | | | | | | | | | |
| Oils/glycerin/ | 7.74 | 4.82 | 4.23 | 7.74 | 4.82 | 4.23 | 7.74 | 4.82 | 4.23 | 7.40 |
| lecithin | | | | | | | | | | |
| Water | 0.57 | 0.35 | 0.30 | 0.57 | 0.35 | 0.30 | 0.57 | 0.35 | 0.30 | 2.54 |
| Erythritol | Coarse | Coarse | Coarse | Coarse | Coarse | Coarse | Coarse | Coarse | Coarse | — |
| Granulation | | | | | | | | | | |

*Acids include malic and citric acid.

The formulations of the Fruit # 2 chewing gum samples are shown in Table 5. Erythritol was present as coarse granules. The sorbitol and mannitol in sample #10 (control) was of standard grade (i.e. similar to “fine” erythritol granular size)

TABLE 5
Fruit #2 Gum Formulations

| Ingredients | Samples | | | | | | | | | |
|---|---|---|---|---|---|---|---|---|---|---|
| (weight %) | #1 | #2 | #3 | #4 | #5 | #6 | #7 | #8 | #9 | #10 |
| Sorbitol | 49.2 | 36.9 | 32.6 | 48.4 | 36.1 | 31.8 | 47.6 | 35.3 | 31.0 | 51.5 |
| Mannitol | 0.3 | 0.2 | 0.15 | 0.3 | 0.2 | 0.15 | 0.3 | 0.2 | 0.15 | 0.3 |
| Erythritol | 0 | 16 | 21 | 0 | 16 | 21 | 0 | 16 | 21 | 0 |
| Hydrogenated | 1.0 | 0.6 | 0.55 | 1.0 | 0.6 | 0.55 | 1.0 | 0.6 | 0.55 | 1.0 |
| Starch | | | | | | | | | | |
| Hydrolysate | | | | | | | | | | |
| Gum Base | 32 | 32 | 32 | 32 | 32 | 32 | 32 | 32 | 32 | 31 |
| Filled Beads | 0.8 | 0.8 | 0.8 | 1.6 | 1.6 | 1.6 | 2.4 | 2.4 | 2.4 | 0 |
| Flavor, Color | 3.1 | 3.1 | 3.1 | 3.1 | 3.1 | 3.1 | 3.1 | 3.1 | 3.1 | 3.5 |
| & Sensates | | | | | | | | | | |
| Acid* | 3 | 3 | 3 | 3 | 3 | 3 | 3 | 3 | 3 | 1 |
| High Intensity | 1.9 | 1.9 | 1.9 | 1.9 | 1.9 | 1.9 | 1.9 | 1.9 | 1.9 | 1.8 |
| Sweeteners | | | | | | | | | | |
| Oils/glycerin/ | 8.1 | 5.1 | 4.6 | 8.1 | 5.1 | 4.6 | 8.1 | 5.1 | 4.6 | 7.4 |
| lecithin | | | | | | | | | | |
| Water | 0.6 | 0.4 | 0.3 | 0.6 | 0.4 | 0.3 | 0.6 | 0.35 | 0.3 | 2.5 |
| Erythritol | — | Coarse | Coarse | | Coarse | Coarse | | Coarse | Coarse | — |
| Granulation | | | | | | | | | | |

*Acids include malic and citric acid

The consumer sensory test used to evaluate theses samples was a sequential monadic complete block design, in which half of the test consumers were male and half were female, and all were 18 to 49 years old. Sample size was N=102-104 (depending on test cell). Three cells were run, one flavor per cell. All products were seen by all consumers one after another. Serving order was rotated and balanced. All consumers were asked the question “how effective was this gum in giving your mouth a hydrating sensation?” The figures show the percentage of the overall consumers who answered the question with at least a 1) extremely effective or 2) very effective response. Capital letters indicate significant difference between samples at a 95% confidence. Lower case letters indicate significant difference between samples at a 90% confidence.

Tables 6-8 include results of consumer sensory data for nine samples of chewing gums of each flavor having combinations of erythritol amounts of 0, 16 or 21% by weight of the chewing gum and filled bead amounts of 0.8, 1.6 or 2.4% by weight of the chewing gum.

Table 6 illustrates the consumer sensory test data for the Mint chewing gum samples in Table 3. The data show a peak effective amount of hydration sensation for the Mint at an erythritol amount of 21 wt. % and a filled bead amount of 1.6 wt %.

TABLE 6
Mint Consumer Sensory Test Data

| Sample | | Bead | Erythritol | | Significant |
|---|---|---|---|---|---|
| # | Identifier | Level | Level | Hydration | Difference |
| #6 | C | 1.6 | 21 | 69 | bdefGHJK |
| #3 | A | 0.8 | 16 | 66 | bGhJK |
| #9 | D | 2.4 | 16 | 62 | GhJ |
| #7 | F | 2.4 | 0 | 62 | GhJ |
| #2 | E | 0.8 | 21 | 62 | GhJ |
| #4 | B | 1.6 | 0 | 59 | gJ |
| #5 | K | 1.6 | 16 | 57 | gj |
| #8 | H | 2.4 | 21 | 56 | j |
| #1 | G | 0.8 | 0 | 50 | |
| #10 | J | 0.0 | 0 | 47 | |

Table 7 illustrates consumer sensory test data for the Fruit #1 chewing gum samples in Table 4. The data show a peak effective amount of hydration sensation for Fruit #1 occurred at an erythritol amount of 21 wt. % and a filled bead amount of 1.6 wt. %.

TABLE 7
Fruit #1 Consumer Sensory Test Data

| Sample | | Bead | Erythritol | | Significant |
|---|---|---|---|---|---|
| # | Identifier | Level | Level | Hydration | Difference |
| #6 | E | 1.6 | 21 | 66 | aBcdFHJK |
| #2 | G | 0.8 | 16 | 62 | bcfHJk |
| #3 | D | 0.8 | 21 | 61 | bfHJk |
| #8 | A | 2.4 | 16 | 58 | fhJ |
| #5 | C | 1.6 | 16 | 56 | hj |
| #1 | K | 0.8 | 0 | 55 | hj |
| #9 | B | 2.4 | 21 | 54 | j |
| #7 | F | 2.4 | 0 | 51 | |
| #10 | H | 0 | 0 | 48 | |
| #4 | J | 1.6 | 0 | 46 | |

Table 8 illustrates consumer sensory test data for Fruit #2 chewing gum samples in Table 5. The data shows that the peak effective amount of hydration sensation for the Fruit #2 occurred at an erythritol amount of 0 wt. % and 21 wt. %, each at a corresponding filled bead amount of 1.6 wt. %.

TABLE 8
Fruit #2 Consumer Sensory Test Data

| Sample | | Bead | Erythritol | | Significant |
|---|---|---|---|---|---|
| # | Identifier | Level | Level | Hydration | Difference |
| #4 | G | 1.6 | 0 | 61 | abj |
| #6 | C | 1.6 | 21 | 60 | bj |
| #1 | H | 0.8 | 0 | 60 | bj |
| #2 | D | 0.8 | 16 | 59 | bj |
| #9 | E | 2.4 | 21 | 58 | bj |
| #8 | K | 2.4 | 16 | 58 | bj |
| #10 | F | 0 | 0 | 56 | |
| #5 | A | 1.6 | 16 | 55 | |
| #3 | B | 0.8 | 21 | 51 | |
| #7 | J | 2.4 | 0 | 51 | |

Generally, the filled beads at about 1.6 wt. % and the erythritol at about 21 wt. % were found to be the best options for the three formulations in terms of creating a perception of hydration.

### Example 2

This study investigated whether consumers perceive erythritol gum having 1) 100% fine erythritol and 2) 50%/50% coarse/fine erythritol as mouth-watering. To do this, the consumer mouth-watering sensation (e.g. sensation of hydration) of a erythritol gum (100% fine erythritol & 50/50 coarse/fine erythritol) (the “experimental gum”) was compared to a sorbitol/mannitol control (mint flavored) (the “control gum”). The formulations of these gums with erythritol and the control are shown in Table 9. There was no acid in any of these samples.

TABLE 9
Gum With Erythritol Formulations

| | Sample | | |
|---|---|---|---|
| Ingredients (weight %) | #1 | #2 | #3 |
| Sorbitol | 0 | 0 | 48.33 |
| Mannitol | 0 | 0 | 4.63 |
| Erythritol | 56.28 | 57.28 | 0 |
| Erythritol Type | Fine | 50/50 | N/A |
| | | fine/coarse | |
| Gum Base | 30.00 | 30.00 | 30.00 |
| Calcium Carbonate | 3.9 | 3.9 | 0 |
| Flavor, Colors & Sensates | 2.95 | 2.95 | 2.86 |
| High Intensity Sweeteners | 4.08 | 4.08 | 4.08 |
| Acids | 0 | 0 | 0 |
| Oils/glycerin/lecithin | 3.30 | 2.30 | 7.60 |
| Water | 0 | 0 | 2.50 |
| Total | 100 | 100 | 100 |

The consumer sensory test was a sequential monadic complete block design. N=92. Each consumer evaluated two pairs of products (control vs. fine erythritol experimental and control vs. 50/50 coarse/fine erythritol experimental). Serving order was rotated and balanced across the pairs and control vs. experimental.

Consumers were asked to choose which sample of the two is “more mouth-watering” or “no difference in mouth-watering”. Open-ended responses were collected during a 4-minute chew as well as after consumers had evaluated each pair of products.

The crystal-like texture of coarse erythritol in gum was noticeable to consumers. Consumers were not specifically told to expect crystal-like texture prior to tasting the samples. The core statement prior product evaluation was “Today you will taste several mouth-watering chewing gums.” A majority (55 of 92) consumers mentioned the crystal/sand like texture of coarse/fine erythritol gum in their open-ended responses: 22 of them liked it, 17 of them disliked it, and 16 of them noted it but did not specify likes/dislikes.

Significantly more consumers perceived the experimental gum being more mouth-watering (i.e. having increased sensation of hydration) than the control gum (at a significant difference at 90% confidence level). Both the fine erythritol gum and coarse/fine erythritol gum were perceived to be more mouth-watering than the control. All polyols in control sample (i.e., sorbitol & mannitol) were substituted using fine erythritol or 50/50 coarse/fine erythritol.

Fine erythritol containing gum (at a significant difference at 95% confidence level): 54 of 92 consumers selected the fine erythritol containing gum as the more mouth watering sample than Control. About a third (30 of 92) of consumers selected the control as the more mouth watering sample than fine erythritol containing gum. Eight of 92 consumers thought there was no difference in mouth watering between control and fine erythritol containing gum.

Coarse/fine erythritol containing gum (at a significant difference at 95% confidence level): 58 of 92 consumers selected coarse/fine erythritol containing gum as the more mouth watering sample over the control. About a third of the consumers (30 of 92) selected control as the more mouth watering sample over coarse/fine erythritol containing gum. Four of 92 consumers thought there was no difference in mouth watering between control and coarse/fine erythritol containing gum.

### Example 3

Additional formulations of fruit flavored chewing gum containing coarse and fine erythritol are shown in Table 10. Two samples of chewing gum containing 20% erythritol were compared (by 12 panelists) against a sample containing no erythritol. Samples #2 and #3 were perceived as more mouthwatering and as having more flavor intensity than sample # 1 (control). Test results are in Table 11. The sensory test was a sequential monadic design, with samples evaluated blind and in rotated order. Participants rated samples on a 7 point scale (7 being extremely effective; 5 being moderately effective) as to effectiveness of giving a mouthwatering sensation and on a 7 point scale (7 being extremely fruity; 5 being moderately fruity) as to amount of fruit flavor intensity.

TABLE 10
Gum Formulas with 20% Erythritol

| | Sample | | |
|---|---|---|---|
| Ingredients (weight %) | #1 | #2 | #3 |
| Sorbitol | 53.0 | 33.0 | 33.0 |
| Eythritol Fine | 0.0 | 20.0 | 0.0 |
| Erythritol Coarse | 0.0 | 0.0 | 20.0 |

TABLE 11
Sensory Results

| | Sample | | |
|---|---|---|---|
| | #1 | #2 | #3 |
| Mouthwatering | 5 | 5.42 | 5.17 |
| Flavor Intensity | 5.17 | 5.33 | 5.33 |

### Example 4

Additional formulations of fruit flavored chewing gum containing coarse and fine erythritol are shown in Table 12. Product #1 and #2 were perceived to provide a mouthwatering effect. Product #2 additionally contained a sensate, which was indicated by the supplier to create salivation.

TABLE 12
Gum with Erythritol Formulations

Sample

| Ingredients (weight %) | #1 | #2 |
|---|---|---|
| Sorbitol | 33.6 | 30.4 |
| Erythritol (form) | 20 (coarse) | 20 (fine) |
| Gum Base | 30 | 27 |
| Flavors and Colors | 2.8 | 3.5 |
| Acids* | 1.7 | 1.5 |
| High Intensity Sweeteners | 1.8 | 0.5 |
| Sensate | 0 | 0.3 |
| Oils/lecithin/glycerol | 0 | 0.3 |
| Polyol Syrup | 10 | 16.7 |
| Total | 100 | 100 |

*Acids include citric, malic, fumaric acids.

### Example 5

Additional formulations of the Fruit #1 gum are shown in Table 13 and for Fruit #2 in Table 14. The ingredients can be adjusted to soften or firm gum texture without needing to reduce erythritol content.

TABLE 13
Alternative Fruit #1 Gum Formulations

| | Sample | | | |
|---|---|---|---|---|
| Ingredients (weight %) | #1 | #2 | #3 | #4 |
| Sorbitol | 33.2 | 36.4 | 37.9 | 38.6 |
| Mannitol | 0.2 | 0.1 | 0.1 | 0.1 |
| Xylitol | 0.0 | 0.5 | 0.0 | 0.0 |
| Erythritol | 21.0 | 21.0 | 21.0 | 21.0 |
| Hydrogenated Starch Hydrolysate | 0.6 | 0.4 | 0.4 | 0.4 |
| Gum Base | 32.0 | 30.0 | 28.8 | 28.1 |
| Flavor Beads | 1.6 | 1.6 | 1.6 | 1.6 |
| Flavor, Color & Sensates | 2.4 | 2.1 | 2.2 | 2.2 |
| Acid | 3.5 | 3.5 | 3.5 | 3.5 |
| High Intensity Sweeteners | 1.0 | 1.0 | 1.0 | 1.0 |
| Oils/glycerin/lecithin | 4.2 | 3.2 | 3.3 | 3.3 |
| Water | 0.3 | 0.2 | 0.2 | 0.2 |

TABLE 14
Alternative Fruit #2 Formulations

| | Product | | | |
|---|---|---|---|---|
| Ingredients (weight %) | #1 | #2 | #3 | #4 |
| Sorbitol | 36.1 | 36.9 | 37.2 | 32.6 |
| Mannitol | 0.2 | 0.1 | 0.1 | 0.2 |
| Xylitol | 0.0 | 0.5 | 0.0 | 0.0 |
| Erythritol | 21.0 | 21.0 | 21.0 | 21.0 |
| Hydrogenated Starch Hydrolysate | 0.6 | 0.4 | 0.4 | 0.6 |
| Gum Base | 28.8 | 29.0 | 28.8 | 32.0 |
| Flavor Beads | 1.6 | 1.6 | 1.6 | 1.6 |
| Flavor, Color & Sensates | 2.6 | 2.6 | 2.6 | 2.9 |
| Acid | 3.5 | 3.6 | 3.6 | 3.5 |
| High Intensity Sweeteners | 1.0 | 1.0 | 1.0 | 1.0 |
| Oils/glycerin/lecithin | 4.3 | 3.1 | 3.5 | 4.3 |
| Water | 0.3 | 0.2 | 0.2 | 0.3 |

### Example 6

Additional formulations of the gum formulations are shown in Table 15 and Table 16. Table 15 includes gum formulations containing acid and sorbitol, erythritol, or xylitol. Table 16 includes gum formulations containing only a very low amount of acid (added for fruit flavor) and sorbitol, erythritol, or xylitol. Table 17 includes sensory test results for the samples in Table 15 and Table 16.

TABLE 15
Fruit Gum Formulations With Acid

Sample

| | #1 | #2 | #3 | #4 | #5 |
|---|---|---|---|---|---|
| Erythritol Coarse | 59.0 | 29.5 | 0.0 | 0.0 | 0.0 |
| Erythritol Fine | 0.0 | 29.5 | 58.0 | 0.0 | 0.0 |
| Xylitol | 0.0 | 0.0 | 0.0 | 58.0 | 0.0 |
| Sorbitol | 0.0 | 0.0 | 0.0 | 0.0 | 53.0 |
| Gum Base | 32.0 | 32.0 | 32.0 | 32.0 | 32.0 |
| Oli/glycerin/lecithin | 1.7 | 1.7 | 2.7 | 2.7 | 7.7 |
| Flavors, Colors & | 2.4 | 2.4 | 2.4 | 2.4 | 2.4 |
| Sensates | | | | | |
| Acids | 3.8 | 3.8 | 3.8 | 3.8 | 3.8 |
| High Intensity | 1.1 | 1.1 | 1.1 | 1.1 | 1.1 |
| Sweeteners | | | | | |
| Calcium Carbonate | 0.0 | 0.0 | 0.0 | 0.0 | 0.0 |

TABLE 16
Fruit Gum Formulations With Only Flavoring Acid

Sample

| | #6 | #7 | #8 | #9 | #10 |
|---|---|---|---|---|---|
| Erythritol Coarse | 59.0 | 29.5 | 0.0 | 0.0 | 0.0 |
| Erythritol Fine | 0.0 | 29.5 | 58.0 | 0.0 | 0.0 |
| Xylitol | 0.0 | 0.0 | 0.0 | 58.0 | 0.0 |
| Sorbitol | 0.0 | 0.0 | 0.0 | 0.0 | 53.0 |
| Gum Base | 32.0 | 32.0 | 32.0 | 32.0 | 32.0 |
| Oli/glycerin/lecithin | 1.7 | 1.7 | 2.7 | 2.7 | 7.7 |
| Flavors, Colors & | 2.4 | 2.4 | 2.4 | 2.4 | 2.4 |
| Sensates | | | | | |
| Acids | 0.8 | 0.8 | 0.8 | 0.8 | 0.8 |
| High Intensity | 1.1 | 1.1 | 1.1 | 1.1 | 1.1 |
| Sweeteners | | | | | |
| Calcium Carbonate | 3.0 | 3.0 | 3.0 | 3.0 | 3.0 |

TABLE 17
Sensory Results for Fruit Gum Formulations

| Sam- | Test Results | | | | |
|---|---|---|---|---|---|
| ple | Identifier (for | Effective- | | Strength | |
| Num- | Statistical | ness of | | of Fruit- | |
| ber | Differences) | Hydration | | iness | |
| 1 | A | 7.18 | BDEFGHJK | 6.70 | bDeFGHJK |
| 2 | B | 6.77 | FgJK | 6.33 | FGhJK |
| 3 | C | 6.90 | deFGhJK | 6.72 | bDeFGHJK |
| 4 | D | 6.59 | JK | 6.29 | FGhJK |
| 5 | E | 6.56 | JK | 6.38 | FGHJK |
| 6 | F | 6.33 | K | 5.84 | K |
| 7 | G | 6.41 | K | 5.85 | K |
| 8 | H | 6.52 | JK | 5.96 | Jk |
| 9 | I | 6.13 | K | 5.60 | k |
| 10 | J | 5.37 | | 4.77 | |

The sensory test was a sequential monadic design, with samples evaluated blind and in rotated order. N=92. Participants rated samples on a 9 point scale (9 being extremely effective; 5 being moderately effective) as to effectiveness of giving a mouthwatering sensation and on a 9 point scale (9 being extremely fruity; 5 being moderately fruity) as to amount of fruit flavor intensity.

The sensory test data show that the mouth watering/hydration sensation and fruitiness were driven by both polyols and acids. Erythritol chewing gums were significantly higher than the sorbitol containing (control) chewing gum in mouth watering and fruitiness when no acid was present. Chewing gums with fine erythritol had higher mouth watering and fruitiness scores than chewing gums with xylitol when no acid was present. Chewing gums with erythritol had significantly stronger mouth watering scores than xylitol and sorbitol gums when acid was present.

Various changes and modifications to the presently preferred embodiments described herein will be apparent to those skilled in the art. Such changes and modifications can be made without departing from the spirit and scope of the present subject matter and without diminishing its intended advantages. Therefore, such changes and modifications are intended to be covered by the appended claims.

1-15. (canceled)

16. A confectionary product containing an effective mouthwatering amount of erythritol granules.

17. A confectionary product of claim 16, further containing 0.1 to 5.0 wt. % food grade acid.

18. A confectionary product of claim 16, in which the confectionery product contains 5 to 90 wt. % of said erythritol granules and in which 5 to 90 wt. % of the erythritol granules are retained on a #60 ASTM E11 Series Sieve.

19. A confectionary product of claim 18, further containing 0.1 to 5.0 wt. % food grade acid.

20. A confectionary product of claim 18, further containing 0.1 to 5.0 wt. % filled beads.

21. A confectionary product of claim 18, in which the confectionary product is a chewing gum.

22. A confectionary product of claim 18, in which the confectionary product is selected from the group consisting of jelly candies, pressed tablets, chewy candies, hard candies, nougats, licorice, and combinations thereof.

23. A chewing gum comprising a gum base, a bulking agent, and a flavor component in which the bulking agent comprises an effective mouth-watering blend of erythritol granules which are retained on a #60 ASTM E11 Series Sieve.

24. A chewing gum of claim 23, in which at least 75% of erythritol granules contained in the product are retained on a #60 ASTM E11 Series Sieve.

25. A chewing gum of claim 23, in which the erythritol granules comprise up to 90 wt. % of the bulking agent in the chewing gum.

26. A chewing gum of claim 23, further comprising 0.1 to 5.0 wt. % food grade acid.

27. A chewing gum of claim 23, further comprising 0.1 to 5.0 wt. % filled beads.

28. A method to provide a sensation of hydration to a consumer comprising consuming a confectionary product containing an effective mouthwatering amount of erythritol granules retained on a #60 ASTM E11 Series Sieve.

29. A method of claim 28, further comprising at least one of 0.1 to 5.0 wt. % filled beads and 0.1 to 5.0 wt. % food grade acid.

30. A method of claim 28, in which the confectionary product is a chewing gum.

31. A method of claim 28, in which the confectionary product is selected from the group consisting of jelly candies, pressed tablets, chewy candies, hard candies, nougats, licorice, and combinations thereof.
